(19) United States
(12) Patent Application Publication
(10) Pub. No.: US 2024/0420019 A1
(43) Pub. Date: Dec. 19, 2024

(54) VALIDATING MACHINE LEARNING MODELS FOR DEPLOYMENT TO CLOUD INFRASTRUCTURE

(71) Applicant: Microsoft Technology Licensing, LLC, Redmond, WA (US)

(72) Inventors: Eli CORTEZ, Parkland, FL (US); Matheus DE OLIVEIRA LEAO, Seattle, WA (US); Roberto LOURENCO DE OLIVEIRA, JR., Kirkland, WA (US); Raphael GHELMAN, Kirkland, WA (US); Maihara Gabrieli SANTOS, Vancouver (CA)

(21) Appl. No.: 18/336,940

(22) Filed: Jun. 16, 2023

(51) Int. Cl. G06N 20/00

(52) U.S. Cl. CPC G06N 20/00

(57) ABSTRACT

A computerized method validates trained models in stage environments prior to deployment to production environments. A validation dataset is generated using a trained model of a first version and sampled input data as input to the trained model. The trained model of the first version is then deployed to a stage environment with the generated validation dataset. The deployed model of the first version is validated in the stage environment using the generated validation dataset and it is determined that results of the validation indicate that the trained model of the first version is invalid. Based on the invalid results, an invalidity action associated with the trained model of the first version is performed. The described method enables computationally efficient validation of accuracy and performance of trained models in stage environments, thereby reducing the likelihood that an inaccurate or underperforming model is deployed to associated production environments.

### BACKGROUND

In complex cloud computing systems, new versions of machine learning models can compromise usage of those models. For example, inaccurate exporting of feature schemas or increases in inference time in a new version of a model may be harmful to a latency-sensitive service that uses the model. Efficient validation of new versions of models presents significant challenges due to differing requirements for different types of trained models in different types of environments.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for validating trained models in stage environments prior to deployment to production environments is described. A validation dataset is generated using a trained model of a first version and sampled input data as input to the trained model. The trained model of the first version is then deployed to a stage environment with the generated validation dataset. The deployed model of the first version is validated in the stage environment using the generated validation dataset and it is determined that results of the validation indicate that the trained model of the first version is invalid. Based on the invalid results, an invalidity action associated with the trained model of the first version is performed.

### BRIEF DESCRIPTION OF THE DRAWINGS

The present description will be better understood from the following detailed description read considering the accompanying drawings, wherein:

FIG. 1 is a block diagram illustrating an example system configured for validating trained models prior to deploying them in production environments;

FIG. 2 is a sequence diagram illustrating an example process for validating trained models in a stage environment prior to deploying them in a production environment:

FIG. 3 is a flowchart illustrating an example method for validating trained models prior to deploying them in production environments:

FIG. 4 is a flowchart illustrating an example method for validating trained models in stage environments using a group of validation tests; and

FIG. 5 illustrates an example computing apparatus as a functional block diagram.

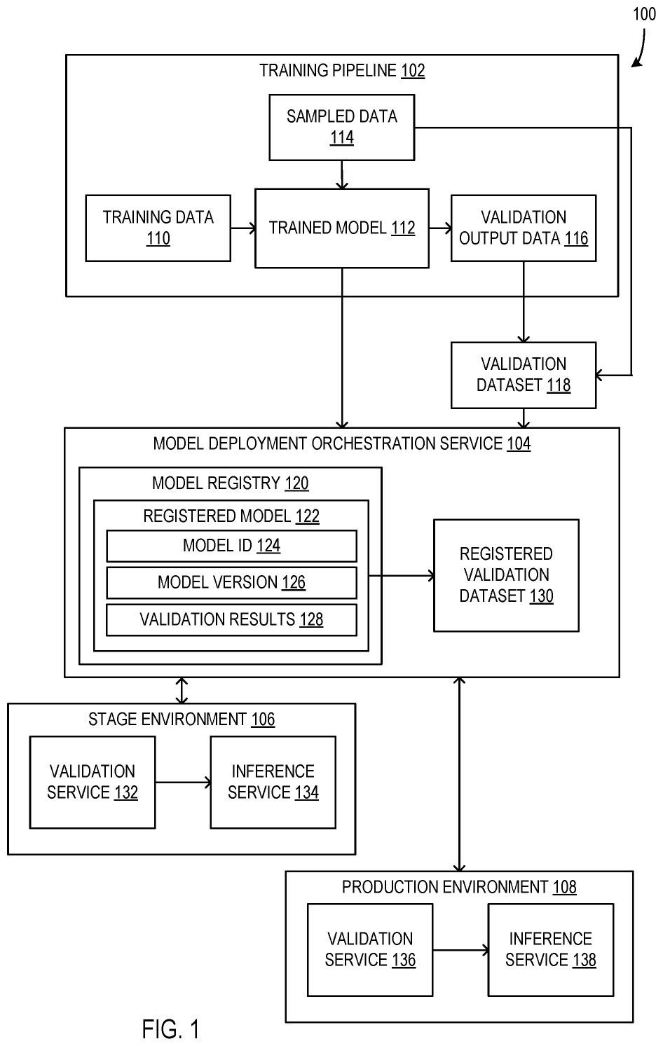

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

In some examples, trained models are validated in stage environments prior to deployment to production environments in computing systems. For example, validation datasets are generated when the training of a version of a model is completed. The model is then registered with a model deployment orchestration (MDO) service in association with a model identifier (ID) and model version. Both the registered model and its validation dataset are deployed to a stage environment. The stage environment mimics a production environment, in that the stage environment is substantially the same as the production environment in which the registered model is targeted for eventual deployment. The deployed model performs model operations, such as inference operations, in the stage environment using sampled input data from the validation dataset as input. The output from these operations is compared to validation output data from the validation dataset to validate the accuracy of the deployed model. If the outputs match, the deployed model is found to be valid with respect to accuracy. If the outputs do not match, the deployed model is found to be invalid with respect to accuracy. In other examples, other aspects of the deployed model, such as latency or other performance metrics, are tested during the validation process in the stage environment. Results of the validation in the stage environment are provided to the MDO service and, if the registered model is found to be valid based on those results, the registered model is deployed to the associated production environment. Alternatively, if the registered model is found to be invalid based on the results, the model is blocked or otherwise prevented from being deployed to the production environment. Additionally, or alternatively, invalidity actions associated with the invalid registered model are performed, such as sending notifications of the invalidity, causing the model to be re-validated, prioritizing the training of a next version of the model, or the like.

The disclosure operates in an unconventional manner at least by creating a framework for the validation and safe deployment of machine learning models and associated training pipelines to cloud infrastructure. The use of the generated validation datasets for each model and the MDO service to manage the validation of the models enhances the system's capability to validate the process of exporting models to different environments and to validate the models compatibility with those different environments. This framework is flexible and allows new and different aspects of machine learning models to be validated with small configuration changes. These features enable validation of models to save significant time and computing system resources, such as would otherwise be spent dealing with issues arising from the deployment of inaccurate and/or slow models to production environments.

Further, the disclosure enables fine-grained control over the training pipelines. This control enables the system to generate sample validation sets that are similar to what the trained model will receive as input when operating in the production environment. Thus, there is a high degree of flexibility regarding the types of models that can be validated, and the validation processes are highly accurate due to the use of closely matching sampled input data during those validation processes.

FIG. 1 is a block diagram illustrating an example system 100 configured for validating trained models (e.g., registered model 122 and/or trained model 112) prior to deploying them in production environments 108. In some examples, the system 100 includes a training pipeline 102 configured for generating and training models, an MDO service 104 configured for managing registered models 122 and enabling validation thereof using registered validation datasets 130, a stage environment 106 configured to enable models to be validated in an environment that is substantially the same as the production environment 108, and the production environment 108 for deploying and using the validated models as part of an inference service 138.

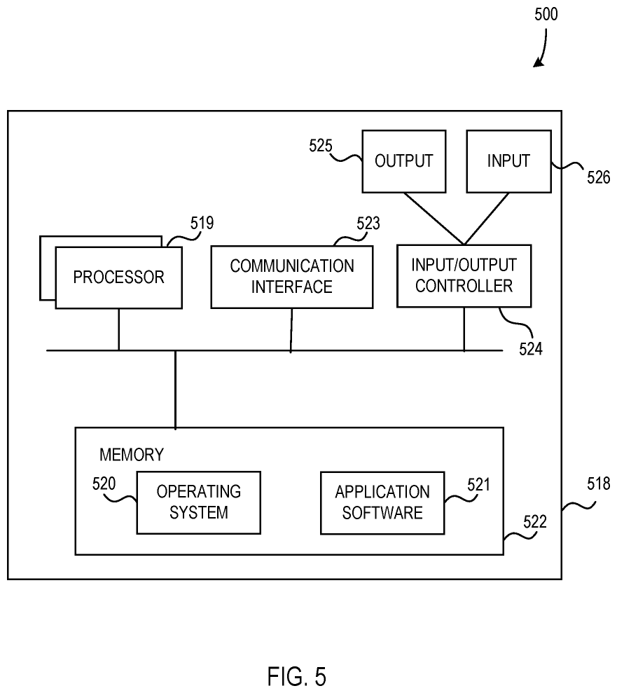

Further, in some examples, the system 100 includes one or more computing devices (e.g., the computing apparatus of FIG. 5) that are configured to communicate with each other via one or more communication networks (e.g., an intranet, the Internet, a cellular network, other wireless network, other wired network, or the like). In some examples, the system 100 is located on and/or executed on a single computing device. Alternatively, in some examples, entities of the system 100 are configured to be distributed between the multiple computing devices and to communicate with each other via network connections. For example, the MDO service 104 is executed on a first computing device and the stage environment is executed on a second computing device. In such an example, the first and second computing devices are configured to communicate with each other via a network connection. In other examples, other organizations of computing devices are used to implement the system 100 without departing from the description.

The training pipeline 102 includes hardware, firmware, and/or software configured to train models 112 using training data 110 and machine learning techniques. In some examples, the training pipeline 102 is configured to train a single type of model while in other examples, the training pipeline 102 is configured to train multiple types of models in series or in parallel. Further, the training pipeline 102 is configured to train new versions of previously trained models.

In some examples, the trained model 112 is trained by the training pipeline 102 using training data 110 and machine learning techniques. For example, the trained model 112 is trained to perform inference tasks based on input data. In such examples, such inference tasks include classification of the input data into one or more categories, predictions about what data will come next or what will occur later based on the input data, determination of lines that best fit input data using regression, or the like. It should be understood that, in some examples, the machine learning techniques used to generate and train the trained model 112 include deep learning training techniques and/or other techniques using neural networks. Additionally, or alternatively, the machine learning techniques include using supervised learning, unsupervised learning, reinforcement learning, or some combination thereof. Further, in some examples the machine learning techniques include using inductive learning, deductive learning, and/or transductive learning to train the trained model 112. In other examples, other types of machine learning techniques are used without departing from the description.

The training pipeline 102 is further configured to generate or otherwise identify a set of sampled data 114 that is used as part of the validation dataset 118 for the trained model 112. It should be understood that the sampled data 114 is generated or otherwise identified for each version of each trained model 112 that is trained by the training pipeline 102. When the training of the trained model 112 is complete, the training pipeline 102 provides the sampled data 114 to the trained model 112 as input and collects the output of the trained model 112 as validation output data 116. The sampled data 114 and validation output data 116 are combined to form the validation dataset 118 that is associated with and specific to the trained model 112 and version with which the sampled data 114 was used to generate the validation output data 116.

The training pipeline 102 provides the trained model 112 and the associated validation data set 118 to the MDO service 104. In some examples, the training pipeline 102 is configured to use specific data formats that enable the export of the trained model 112 and associated data to a variety of frameworks (e.g., Open Neural Network Exchange (ONNX) formats). The MDO service 104 includes hardware, firmware, and/or software configured to storing registered models 122, associated registered validation sets 130, and other data associated therewith. Further, the MDO service 104 is configured to deploy or otherwise provide registered models 122 for deployment to the stage environment 106 and the production environment 108 as described herein.

The model registry 120 of the MDO service 104 stores and/or otherwise manages registered models 122 and associated registered validation data sets 130. A registered model 122 in the model registry 120 has a model ID 124 and a model version 126 that are used to identify the specific model and version of the registered model 122. Further, a registered model 122 has validation results 128 if the registered model 122 has been validated (e.g., in the stage environment 106). The registered model 122 is linked to or otherwise associated with a registered validation dataset 130. For example, the trained model 112 becomes a registered model 122 upon being registered with the MDO service 104 and it is linked to the validation dataset 118, which becomes a registered validation dataset 130 upon being registered with the MDO service 104.

It should be understood that the MDO service 104 is configured for storing and/or managing a plurality of different registered models 122 and associated validation datasets 130 at a time. For example, the MDO service 104 stores and/or manages some registered models 122 that have been validated in a stage environment 106 and have validation results 128, some registered models 122 that have not yet been validated in a stage environment 106 and do not have validation results 128, and some registered models 122 that have been deployed and validated in a production environment 108 as described herein.

The system 100 is configured to validate the registered models 122 of the MDO service 104. After a registered model 122 is first registered with the MDO service 104, it is deployed to a stage environment 106 that is substantially the same as the production environment 108 for which the registered model 122 is intended. In some examples, the stage environment is a production environment in that it has access to the same databases, uses the same sets of credentials, and runs on similar machine infrastructure as an associated production environment. In such examples, the difference between the stage environment and the production environment is that the stage environment receives reduced quantities of traffic that includes synthetic traffic (e.g., traffic that is not from real entities but generated synthetically to test the stage environment). In some examples, the system 100 is configured to queue registered models 122 for deployment to a stage environment 106 and, as compatible stage environments 106 become available, queued registered models 122 are deployed to those environments in the order that they were queued. In other examples, registered models 122 are deployed to stage environments 106 in other ways and/or in other orders without departing from the description.

The stage environment 106 includes hardware, firmware, and/or software configured to execute registered models 122 from the MDO service 104 and for performing other computing functions. For example, the stage environment 106 is configured to execute a registered model 122 as well as to enable users to interact with the stage environment 106 and/or observe the operations of the stage environment 106. Further, in some examples, the stage environment 106 is configured to be at least substantially the same as a production environment 108 such that the behavior of a registered model 122 when executing in the stage environment 106 matches the behavior of that same registered model 122 when executing in the production environment 108.

In some examples, the stage environment 106 includes a validation service 132 and an inference service 134. The registered validation dataset 130 is provided to the validation service 132 and the registered model 122 is deployed to the inference service 134. These two services 132 and 134 are configured to operate together to validate the operation and performance of the registered model 122. In some examples, the validation service 132 provides the sampled data 114 of the validation dataset 130 to the inference service 134 and the inference service 134 executes the registered model 122 and uses the sampled data 114 as input for the registered model 122. The output from the registered model 122 is then provided back to the validation service 132, which compares the output to the validation output data 116 of the validation dataset 130. If the compared output and validation output data 116 are the same, then the registered model 122 is validated for accuracy.

Further, in some examples, validation of a registered model 122 in a stage environment 106 includes validating the registered model 122 for latency and/or other performance metrics. In such examples, the inference service 134 collects timing data and/or other performance data while the registered model 122 is performing inference operations and that timing data is compared a defined latency threshold and/or other performance metric thresholds. If the timing data collected by the inference service 134 meets or is lower than the defined latency threshold, the registered model 122 is validated for latency.

In some examples, the registered model 122 is validated in the stage environment 106 and the validation results 128 of the registered model 122 are provided for storage in the model registry 120 in association with the registered model 122. The system 100 is configured to identify the registered model 122 as being validated and to deploy the registered model 122 to the production environment 108 in response to the validation (e.g., the positive validation results 128). Further, the deployment of the registered model 122 is based on the configuration and/or needs of the production environment 108. For example, the production environment 108 includes a model of the same type as the registered model 122, but of a previous version. Based on the registered model 122 being validated in the stage environment 106, it is then deployed to the production environment 108 as an upgrade or replacement for the model of the previous version.

Further, in some examples, models deployed to the production environment 108 are validated again in that environment using a validation service 136 and an inference service 138. Such validation is performed upon a model being deployed in the production environment 108. Additionally, in some examples, this validation in the production environment 108 is required for the deployed model to be used for normal operations in the production environment. If the deployed model is not validated for some reason, it may be uninstalled or otherwise prevented from performing operations in the production environment 108. Additionally, or alternatively, in some examples, the validation service 136 in the production environment 108 is used for other scenarios, such as checking cluster health in general, without departing from the description.

Additionally, or alternatively, when a registered model 122 is validated and deployed to the production environment 108, it is used in that environment 108 to perform inference tasks, or other types of tasks for which the deployed model is trained.

Alternatively, in examples where the validation of the registered model 122 in the stage environment 106 fails, the registered model 122 is found to be invalid. In such examples, the registered model 122 is blocked from being deployed to the production environment 108. For instance, the validation results 128 of the registered model 122 indicate the invalidity of the model in the stage environment 106 and, as a result, the system 100 is configured to refrain from deploying the registered model to the production environment 108. Further, in some such examples, other model invalidity actions are performed by the MDO service 104 and/or the system 100 in general. For example, another validation of the model is performed or scheduled to be performed in the stage environment 106. Additionally, or alternatively, a model of the same type but of a next version is trained, scheduled to be trained, and/or prioritized to be trained by the training pipeline 102. Further, in some examples, notifications or other messages are sent to notify users and/or other entities associated with the system 100 of the failed validation of the model 122, enabling those users and/or other entities to act in response to the failed validation.

In some examples, the MDO service 104 includes a rules engine that supports filtering rules. Filtering rules are defined for different models that are to be validated in the system 100, including a target value or range that indicates the validity of the model (e.g., a deployment target). For example, a first filtering rule is added to validate that the latency of the registered model 122 is in a defined range and a second filtering rule is added to validate that output data from the registered model 122 is as expected based on the registered validation dataset 130. Below are example representations of the two filtering rules as they are used in a deployment configuration file.

```
“FilterRules”: [
  {
    “Name”: “DeploymentValidationBoundaries”,
    “Arguments”: [
      {
        “Name”: “ValidationStep”,
        “Values”: [
          “Latency”
        ]
      },
      {
        “Name”: “LowerBound”,
        “Values”: [
          “0.3”
        ]
      },
      {
        “Name”: “UpperBound”,
        “Values”: [
          “1.2”
        ]
      }
    ]
  }
]
“FilterRules”: [
  {
    “Name”: “DeploymentValidationExpectedValue”,
    “Arguments”: [
      {
        “Name”: “ValidationStep”,
        “Values”: [
          “SuccessfullyExported”
        ]
      },
      {
        “Name”: “ ExpectedValue”,
        “Values”: [
          “true”
        ]
      }
    ]
  }
]
```

In such examples, the above filter rules are evaluated with respect to the execution of the registered model 122 in the stage environment 106 (e.g., by the validation service 132) and the results of the evaluated rules are stored as validation results 132 with the registered model 122 in the MDO service 104.

Additionally, or alternatively, in some examples, the system 100 includes an application programming interface (API) and/or an associated process that causes the described validation operations to be performed asynchronously. In some cases, the time taken to perform all the operations of a validation process exceed the timeout time of an HTTP request to such an API. In those cases, the API is configured to queue the execution of the validation process and then, the outcome of that validation process may be checked at a later time. In some such examples, the validation processes include many validation steps, including but not limited to the described latency validation and output validation steps. The validation information associated with the validation processes is stored in a model validation table using a schema. An example schema is shown below in Table 1.

TABLE 1

| Column Name | Required? | Type | Description |
|---|---|---|---|
| Timestamp | Yes | DateTime | The time that the entry |
| | | | was written to the table |
| Model Name | Yes | String | The name or ID of the |
| | | | validated model |
| Model Version | Yes | String | The version of the |
| | | | validated model |
| Validation Step | Yes | String | The validation step. |
| | | | (e.g., ‘Latency’, |
| | | | ‘SuccessfullyExported’, |
| | | | ‘Accuracy’) |
| Result Type | Yes | String | The validation result |
| | | | type. (e.g., Float, |
| | | | Boolean, String, etc.) |
| Result | Yes | String | The validation result. |
| | | | The data is of the |
| | | | Result Type. |

Each record stored according to the above schema is associated with a specific model of a specific version using the Model Name and Model Version fields. Each record is also dated according to the Timestamp field. The results of each validation test or step performed during the validation process is recorded as a separate entry in the schema, such that the validation of a single model and version includes records for each of the Latency validation step and the Successfully Exported validation step, for example.

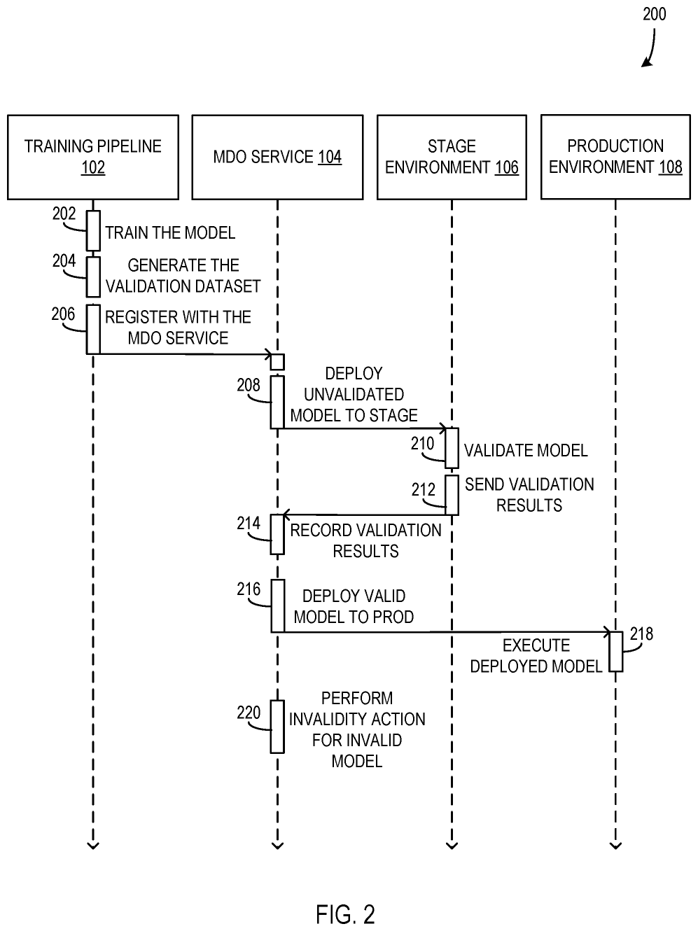

FIG. 2 is a sequence diagram illustrating an example process 200 for validating trained models (e.g., trained model 112 and/or registered model 122) in a stage environment (e.g., stage environment 106) prior to deploying them in a production environment (e.g., production environment 108). In some examples, the process 200 is executed or otherwise performed in a system such as system 100 of FIG. 1.

At 202, the training pipeline 102 is used to train the model and, at 204, the validation dataset (e.g., validation dataset 118) of the trained model is generated. In some examples, the training of the model includes using a set of training data 110 and generating the validation dataset includes providing the trained model 112 sampled data 114 from the training data 110 to generate the validation output data 116. The sampled data 114 and validation output data 116 are combined to form the validation dataset 118 as described herein.

At 206, the model is registered with the MDO service 104, including the generated validation dataset. In some examples, the registration includes adding the model to the model registry 120 as a registered model 122 and linking or otherwise associated the registered model 122 with the registered validation dataset 130 as described herein. Further, the registered model 122 is stored in association with its model ID 124 and model version 126.

At 208, the unvalidated model is deployed to the stage environment 106 for validation. In some examples, the model validation processes from 208-214 are executed in parallel or otherwise at the same time as the training processes from 202-206, such that the training pipeline 102 is configured to train models while the MDO service 104 and stage environment 106 are used to validate other models that have already been trained.

At 210, the model is validated in the stage environment 106 and the validation results are sent to the MDO service 104 at 212. In some examples, validating the model includes finding the model to be valid (e.g., a positive validation result) while, in other examples, validating the model includes finding the model to be invalid (e.g., a negative validation result). Additionally, or alternatively, validating the model includes performing a plurality of validation steps or tests, such as validating the latency of the model and/or validating the accuracy of the model based on the provided validation dataset.

At 214, the validation results received from the stage environment 106 are recorded in the MDO service 104 in association with the validated model based on the model ID and model version of the model. In some examples, the validation results are recorded in a table according to a defined schema as described herein.

At 216, a valid model is deployed to the production environment 108 from the MDO service 104 and, in the production environment 108, the deployed model is executed at 218. In some examples, the deployment of the valid model includes determining that the validation results of the model indicate that the model is valid prior to deploying the model.

At 220, an invalidity action is performed by the MDO service 104 for an invalid model. In some examples, the performance of the invalidity action includes first determining that the validation results of the model indicate that the model is invalid prior to performing the action. Further, in some examples, the invalidity action includes sending a notification indicating that the model has been found to be invalid, preventing or blocking the model from being deployed to the production environment 108, prioritizing the training of another model of the type of the invalid model in order to prepare the next version of the model for use more quickly, or the like.

It should be understood that, in some examples, the processing of valid models at 216-218 and the processing of invalid models at 220 can be performed in parallel or otherwise substantially simultaneously by the MDO service 104. Further, in some examples, the MDO service 104 and associated entities are configured to perform the processing of valid and/or invalid models at the same time as the validation processes from 208-214 and/or the training processes from 202-26 without departing from the description.

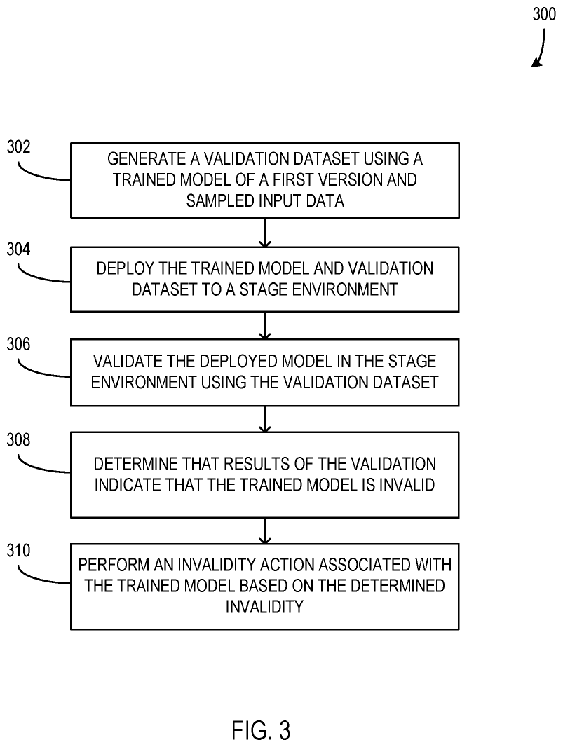

FIG. 3 is a flowchart illustrating an example method 300 for validating trained models (e.g., trained model 112 and/or registered model 122) prior to deploying them in production environments (e.g., production environment 108). In some examples, the method 300 is executed or otherwise performed in a system such as system 100 of FIG. 1.

At 302, a validation dataset is generated using a trained model of a first version and sampled input data. In some examples, the validation dataset is generated to include the sampled input data mapped to output data (e.g., validation output data 116) from the trained model when the trained model performs operations on the sampled input data. Thus, the output data in the validation dataset is expected output of the trained model when the trained model is provided the sampled input data as input. Further, in some examples, the validation dataset includes or is otherwise associated with a model schema that defines details and requirements about the form and/or content of input data required by the trained model. In such examples, the model schema is included in or with the validation dataset such that it can be used in other environments to format input data and/or otherwise determine how the trained model is used in those environments to effectively perform inference operations and/or otherwise generate output data from input data.

At 304, the trained model and validation dataset are deployed to a stage environment. In some examples, as described above, the validation dataset includes or is otherwise associated with a model schema and that schema is provided to the stage environment during the deployment of the trained model and the validation dataset. Further, in some examples, the deployment of the trained model and the validation dataset includes configuring an inference service (e.g., inference service 134) of the stage environment to operate and/or interact with the trained model and to configure a validation service (e.g., validation service 132) to use the validation dataset with the trained model to perform validation tests as described herein.

At 306, the deployed model is validated in the stage environment using the validation dataset. In some examples, the validation of the deployed model includes the deployed model performing a plurality of inference operations using sampled input data from the validation dataset. Data about the performance of the deployed model is collected during and after the performance of the inference operations and the collected data is used to evaluate the validity of the deployed model based on a plurality of validity tests, as described herein. In some such examples, a validity test applied to the deployed model is an accuracy validity test wherein the output of the deployed model is compared to the validity output data in the validation dataset. If the output of the deployed model matches with corresponding validity output data in the validation dataset, the deployed model is valid with respect to that particular validity test. Additionally, or alternatively, a validity test applied to the deployed model is a latency validity test, wherein collected latency data of the performed inference operations is compared to a defined latency range and/or threshold. If the collected latency data fits into the defined latency range and/or is under the defined latency threshold, the deployed model is valid with respect to that particular validity test. In other examples, more, fewer, or different validity tests are used to test the validity of the deployed model in the stage environment without departing from the description.

Additionally, it should be understood that the stage environment used for validating the trained model is substantially the same as an associated production environment to which the trained model is to be deployed if it is found to be valid during the validation process.

At 308, it is determined that the results of the validation of the trained model in the stage environment indicate that the trained model is invalid. In some examples, the trained model is found to be invalid if one or more of the validation tests indicate that the trained model is invalid. For example, if the trained model is found to be valid with respect to an accuracy validity test and found to be invalid with respect to a latency validity test, the trained model is determined to be invalid overall. Further, in some examples, the determination that the trained model is invalid is performed by a service such as the MDO service 104 which is configured to evaluate validation results of registered models when results are received, periodically, and/or based on some other event or trigger.

At 310, an invalidity action associated with the trained model is performed based on the invalidity determination. In some examples, the invalidity action includes at least one of the following: blocking or otherwise preventing the trained model from being deployed to a production environment: sending a notification that the trained model has been found to be invalid: re-validating the trained model: or prioritizing the training of a next version of the trained model in the training pipeline. Further, in some examples, multiple invalidity actions are performed in association with the trained model as described herein.

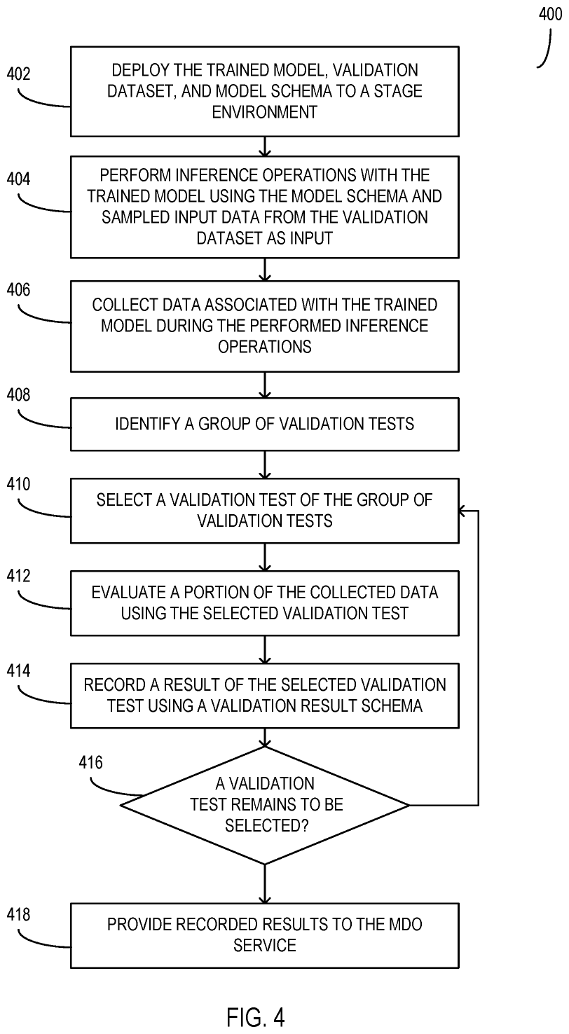

FIG. 4 is a flowchart illustrating an example method 400 for validating trained models (e.g., trained model 112 and/or registered model 122) in stage environments (e.g., stage environment 106) using a group of validation tests. In some examples, the method 400 is executed or otherwise performed in a system such as system 100 of FIG. 1. Further, in some examples, the method 400 is performed as part of another method such as method 300 of FIG. 3. For instance, in some examples, 402-418 occur as part of 304-306 of method 300.

At 402, the trained model, validation dataset, and an associated model schema are deployed to a stage environment, as described herein. At 404, inference operations are performed with the trained model using the model schema and sampled input data from the validation dataset as input. In some examples, the inference operations that are to be performed by the trained model during the validation process are defined in the validation dataset. For example, the validation dataset includes a group of sampled input datasets, and the trained model is used to perform inference operations for each sampled input dataset in the group of sampled input datasets.

Additionally, or alternatively, in some examples, the inference operations performed are based on the type and/or quantity of data that is to be collected and used to evaluate the validity of the trained model. In an example where the evaluation of the latency of the trained model requires that a minimum quantity of inference operations be performed and latency data for each of those inference operations be collected, the trained model is caused to perform at least that quantity of inference operations using the data of the validation dataset. In some such examples, inference operations using the validation dataset are repeated to reach the minimum quantity of performed inference operations. Such inference operation requirements for the validation of the trained model are stored in the validation dataset, the model schema, and/or included in another associated data structure of the trained model.

At 406, data associated with the trained model is collected during the performance of the inference operations. In some examples, the data collected includes output data from the trained model, latency data and/or other performance metric data of the trained model, or the like.

At 408, a group of validation tests is identified and, at 410, a validation test of the group of validation tests is selected. In some examples, the group of validation tests is included with the inference operation requirements described above (e.g., as part of the model schema and/or validation dataset). Further, in some examples, the group of validation tests are configured to be stored and/or represented in a validation result schema as described herein.

At 412, a portion of the collected data is evaluated using the selected validation test. For instance, in an example where the selected validation test is a latency test, the collected latency data is evaluated. Alternatively, in an example where the selected validation test is another performance metric, collected data indicative of that performance metric is evaluated. In other examples where the selected validation test is an accuracy test, at least a portion of the output data from the performance of the inference operations by the trained model is compared to validation output data of the validation dataset to evaluate the associated accuracy test.

At 414, a result of the selected validation test is recorded using a validation result schema and, at 416, if a validation test of the group of validation requests remains to be selected, the process returns to 410 to select a next validation test. Alternatively, if no validation tests remain to be selected, the process proceeds to 418.

At 418, the recorded results of the group of validation tests are provided to the MDO service (e.g., MDO service 104). In some examples, validation results are stored with the associated registered model 122 in the MDO service and used to determine whether to deploy the associated registered model 122 to the production environment with which the stage environment is associated.

### Exemplary Operating Environment

Examples of the present disclosure are operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device. In some examples, validating trained models in stage environments prior to deploying them in production environments as described herein is accomplished by software, hardware, and/or firmware.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Propagated signals per se are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: a processor; and a memory comprising computer program code, the memory and the computer program code configured to cause the processor to: generate a validation dataset using a trained model of a first version and sampled input data as input to the trained model: deploy the trained model of the first version and the generated validation dataset, including the sampled input data mapped to validation output data, to a stage environment: generate test output data using the deployed model of the first version in the stage environment and the sampled input data of the generated validation dataset as input to the deployed model of the first version: validate the deployed model of the first version in the stage environment using the generated test output data and the validation output of the generated validation dataset: determine that results of the validation indicate that the trained model of the first version is invalid; and perform an invalidity action associated with the trained model of the first version based on determining that the results indicate that the trained model of the first version is invalid.

An example computerized method comprises: generating a validation dataset using a trained model of a first version and sampled input data as input to the trained model; deploying the trained model of the first version and the generated validation dataset to a stage environment: validating the deployed model of the first version in the stage environment using the generated validation dataset: determining that results of the validation indicate that the trained model of the first version is invalid; and performing an invalidity action associated with the trained model of the first version based on determining that the results indicate that the trained model of the first version is invalid.

One or more computer storage media have computer-executable instructions that, upon execution by a processor, cause the processor to at least: generate a validation dataset using a trained model of a first version and sampled input data as input to the trained model; deploy the trained model of the first version, the generated validation dataset, and an associated model schema to a stage environment: validate the deployed model of the first version in the stage environment using the generated validation dataset, wherein sampled input data of the generated validation dataset is provided as input to the deployed model of the first version according to the associated model schema: determine that results of the validation indicate that the trained model of the first version is invalid; and perform an invalidity action associated with the trained model of the first version based on determining that the results indicate that the trained model of the first version is invalid.

Alternatively, or in addition to the other examples described herein, examples include any combination of the following:
wherein deploying the trained model of the first version and the generated validation dataset to the stage environment includes providing a model schema of the trained model of the first version to the stage environment; and wherein validating the deployed model of the first version includes providing the sampled input data of the generated validation dataset to the deployed model of the first version according to the provided model schema.
further comprising: storing the trained model and the generated validation dataset in a model registry; and wherein deploying the trained model of the first version to the stage environment includes: determining that the trained model of the first version has not been validated using the model registry; and deploying the trained model of the first version from the model registry to the stage environment.
further comprising: training a second model of a second version using training data; generating a second validation dataset using the trained second model of the second version and sampled input data as input to the trained second model; and wherein at least one of training the second model or generating the second validation dataset is performed simultaneously with validating the deployed model of the first version in the stage environment.
further comprising: validate a second model of a second version in the stage environment using an associated second validation dataset: determine that results of the validation indicate that the second model of the second version is valid; and deploy the second model of the second version to a production environment based on determining that the results indicate that the second model of the second version is valid.
further comprising: initially validating the second model of the second version in the production environment using the associated second validation dataset; and performing inference operations in the production environment using the validated second model of the second version.
wherein validating the deployed model of the first version in the stage environment using the generated validation dataset includes: performing a defined quantity of inference operations with the deployed model of the first version and using the sampled input data as input to the deployed model of the first version: measuring latency of the deployed model of the first version during the performance of the defined quantity of inference operations: determining that the measured latency of the deployed model of the first version falls outside of a defined latency validation range; and based on the determination that the measured latency falls outside the defined latency validation range, generate a validation result indicating that the deployed model of the first version is invalid.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for generating a validation dataset using a trained model of a first version and sampled input data as input to the trained model: an exemplary means for deploying the trained model of the first version and the generated validation dataset to a stage environment: an exemplary means for validating the deployed model of the first version in the stage environment using the generated validation dataset: an exemplary means for determining that results of the validation indicate that the trained model of the first version is invalid; and an exemplary means for performing an invalidity action associated with the trained model of the first version based on determining that the results indicate that the trained model of the first version is invalid.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
generate a validation dataset using a trained model of a first version and sampled input data as input to the trained model;
deploy the trained model of the first version and the generated validation dataset, including the sampled input data mapped to validation output data, to a stage environment;
generate test output data using the deployed model of the first version in the stage environment and the sampled input data of the generated validation dataset as input to the deployed model of the first version;
validate the deployed model of the first version in the stage environment using the generated test output data and the validation output of the generated validation dataset;
determine that results of the validation indicate that the trained model of the first version is invalid; and
perform an invalidity action associated with the trained model of the first version based on determining that the results indicate that the trained model of the first version is invalid.

2. The system of claim 1, wherein deploying the trained model of the first version and the generated validation dataset to the stage environment includes providing a model schema of the trained model of the first version to the stage environment; and
wherein generating the test output data includes providing the sampled input data of the generated validation dataset to the deployed model of the first version according to the provided model schema.

3. The system of claim 1, wherein the memory and the computer program code are configured to cause the processor to further:
store the trained model and the generated validation dataset in a model registry; and
wherein deploying the trained model of the first version to the stage environment includes:
determining that the trained model of the first version has not been validated using the model registry; and
deploying the trained model of the first version from the model registry to the stage environment.

4. The system of claim 3, wherein the memory and the computer program code are configured to cause the processor to further:
train a second model of a second version using training data;
generate a second validation dataset using the trained second model of the second version and sampled input data as input to the trained second model; and
wherein at least one of training the second model or generating the second validation dataset is performed simultaneously with validating the deployed model of the first version in the stage environment.

5. The system of claim 1, wherein the memory and the computer program code are configured to cause the processor to further:
validate a second model of a second version in the stage environment using an associated second validation dataset;
determine that results of the validation indicate that the second model of the second version is valid; and
deploy the second model of the second version to a production environment based on determining that the results indicate that the second model of the second version is valid.

6. The system of claim 5, wherein deploying the second model of the second version to the production environment includes:
initially validating the second model of the second version in the production environment using the associated second validation dataset; and
performing inference operations in the production environment using the validated second model of the second version.

7. The system of claim 1, wherein validating the deployed model of the first version in the stage environment using the generated validation dataset includes:
performing a defined quantity of inference operations with the deployed model of the first version and using the sampled input data as input to the deployed model of the first version;
measuring latency of the deployed model of the first version during the performance of the defined quantity of inference operations;
determining that the measured latency of the deployed model of the first version falls outside of a defined latency validation range; and
based on the determination that the measured latency falls outside the defined latency validation range, generate a validation result indicating that the deployed model of the first version is invalid.

8. A computerized method comprising:
generating a validation dataset using a trained model of a first version and sampled input data as input to the trained model;
deploying the trained model of the first version and the generated validation dataset to a stage environment;
validating the deployed model of the first version in the stage environment using the generated validation dataset;
determining that results of the validation indicate that the trained model of the first version is invalid; and
performing an invalidity action associated with the trained model of the first version based on determining that the results indicate that the trained model of the first version is invalid.

9. The computerized method of claim 8, wherein deploying the trained model of the first version and the generated validation dataset to the stage environment includes providing a model schema of the trained model of the first version to the stage environment; and
wherein validating the deployed model of the first version includes providing the sampled input data of the generated validation dataset to the deployed model of the first version according to the provided model schema.

10. The computerized method of claim 8, further comprising:
storing the trained model and the generated validation dataset in a model registry; and
wherein deploying the trained model of the first version to the stage environment includes:
determining that the trained model of the first version has not been validated using the model registry; and
deploying the trained model of the first version from the model registry to the stage environment.

11. The computerized method of claim 10, further comprising:
training a second model of a second version using training data;
generating a second validation dataset using the trained second model of the second version and sampled input data as input to the trained second model; and
wherein at least one of training the second model or generating the second validation dataset is performed simultaneously with validating the deployed model of the first version in the stage environment.

12. The computerized method of claim 8, further comprising:
validate a second model of a second version in the stage environment using an associated second validation dataset;
determine that results of the validation indicate that the second model of the second version is valid; and
deploy the second model of the second version to a production environment based on determining that the results indicate that the second model of the second version is valid.

13. The computerized method of claim 12, further comprising:
initially validating the second model of the second version in the production environment using the associated second validation dataset; and
performing inference operations in the production environment using the validated second model of the second version.

14. The computerized method of claim 8, wherein validating the deployed model of the first version in the stage environment using the generated validation dataset includes:
performing a defined quantity of inference operations with the deployed model of the first version and using the sampled input data as input to the deployed model of the first version;
measuring latency of the deployed model of the first version during the performance of the defined quantity of inference operations;
determining that the measured latency of the deployed model of the first version falls outside of a defined latency validation range; and
based on the determination that the measured latency falls outside the defined latency validation range, generate a validation result indicating that the deployed model of the first version is invalid.

15. A computer storage medium has computer-executable instructions that, upon execution by a processor, cause the processor to at least:
generate a validation dataset using a trained model of a first version and sampled input data as input to the trained model;
deploy the trained model of the first version, the generated validation dataset, and an associated model schema to a stage environment;
validate the deployed model of the first version in the stage environment using the generated validation dataset, wherein sampled input data of the generated validation dataset is provided as input to the deployed model of the first version according to the associated model schema;
determine that results of the validation indicate that the trained model of the first version is invalid; and
perform an invalidity action associated with the trained model of the first version based on determining that the results indicate that the trained model of the first version is invalid.

16. The computer storage medium of claim 15, wherein validating the deployed model of the first version includes validating at least one of a latency metric of the deployed model of the first version or an accuracy metric of the deployed model of the first version using the generated validation dataset.

17. The computer storage medium of claim 15, wherein the computer-executable instructions, upon execution by a processor, further cause the processor to at least:
store the trained model and the generated validation dataset in a model registry; and
wherein deploying the trained model of the first version to the stage environment includes:
determining that the trained model of the first version has not been validated using the model registry; and
deploying the trained model of the first version from the model registry to the stage environment.

18. The computer storage medium of claim 17, wherein the computer-executable instructions, upon execution by a processor, further cause the processor to at least:
train a second model of a second version using training data;
generate a second validation dataset using the trained second model of the second version and sampled input data as input to the trained second model; and
wherein at least one of training the second model or generating the second validation dataset is performed simultaneously with validating the deployed model of the first version in the stage environment.

19. The computer storage medium of claim 15, wherein the computer-executable instructions, upon execution by a processor, further cause the processor to at least:
validate a second model of a second version in the stage environment using an associated second validation dataset;
determine that results of the validation indicate that the second model of the second version is valid; and
deploy the second model of the second version to a production environment based on determining that the results indicate that the second model of the second version is valid.

20. The computer storage medium of claim 19, wherein deploying the second model of the second version to the production environment includes:
initially validating the second model of the second version in the production environment using the associated second validation dataset; and
performing inference operations in the production environment using the validated second model of the second version.
